(19) United States
(12) Patent Application Publication
(10) Pub. No.: US 2020/0211318 A1
(43) Pub. Date: Jul. 2, 2020

(54) MULTI-GAMING VENDING MACHINE AND METHODS OF MANUFACTURING AND USE THEREOF

(71) Applicant: Intralot S.A. - Integrated Lottery Systems and Services, Athens (GR)

(72) Inventors: Nikolaos Angelopoulos, Athens (GR); Georgios Dimitrakopoulos, Athens (GR); Apostolos Ntalas, Athens (GR)

(21) Appl. No.: 16/513,396

(22) Filed: Jul. 16, 2019

Related U.S. Application Data
(60) Provisional application No. 62/786,668, filed on Dec. 31, 2018.

(51) Int. Cl. G07F 17/32

(52) U.S. Cl. CPC G07F 17/329; G07F 17/3216

(57) ABSTRACT

Certain exemplary embodiments of the present disclosure are directed to a gaming terminal apparatus having an interactive multi-game presenting module. Certain exemplary embodiments of the present disclosure are directed to methods of making and using a gaming terminal apparatus having an interactive multi-game presenting module. In certain embodiments, the interactive multi-game presenting module includes interactive graphical user interfaces configured to allow a user to play games of certain types.

### CROSS-REFERENCE TO RELATED APPLICATIONS

This application claims the priority of U.S. Provisional Patent Application No. 62/786,668 filed Dec. 31, 2018; entitled “MULTI-GAMING VENDING MACHINE AND METHODS OF MANUFACTURING AND USE THEREOF,” which is incorporated herein by reference in its entirety.

### FIELD OF TECHNOLOGY

The present disclosure generally relates to the field of multi-gaming vending machines, and methods of manufacturing the same.

### BACKGROUND OF TECHNOLOGY

Many adults engage participate in lottery games. However, some lottery machines can be easily broken-into, are large and bulky, and do not accommodate disabled individuals. There is thus a need for continued innovation in the field of multi-gaming vending machines, and methods of manufacturing the same.

### SUMMARY OF DESCRIBED SUBJECT MATTER

In some embodiments, the present disclosure provides a gaming terminal apparatus, which includes from five to twenty-five bins in steps of five bins, wherein each bin of the one to twenty-five bins is configured to house at least one physical game piece corresponding to at least one first game of a first type; an accessibility portion, wherein the accessibility portion is positioned at a sufficient distance upward from a bottom of the gaming terminal apparatus to allow a user in a wheelchair to play the at least one first game of the first type, the at least one second game of the second type, and the at least one third game of the third type within a single interactive session, and wherein the accessibility portion comprises: an interactive multi-game presenting module that is programmed to display: at least one first interactive graphical user interface that is configured to allow a user to play the at least one first game of a first type; at least one second interactive graphical user interface that is configured to allow the user to play at least one second game of a second type; at least one third interactive graphical user interface that is configured to allow the user to play at least one third game of a third type; wherein the interactive multi-game presenting module is programmed to allow the user to play the at least one first game of the first type, the at least one second game of the second type, and the at least one third game of the third type within the single interactive session; wherein the single interactive session comprises a plurality of time-related activities that the gaming terminal apparatus permits a user to perform during a distinct time period; wherein the at least one first game of the first type, the at least one second game of the second type, and the at least one third game of the third type are distinct; wherein at least one of the at least one first game of the first type, the at least one second game of the second type, or the at least one third game of the third type is a game that requires the gaming terminal apparatus to dispense to the user at least one physical game piece or at least one game entry confirmation printout, a receiving tray, wherein the receiving tray is configured to receive, from at least one bin of the five to twenty-five bins, at least one of: the at least one first game of the first type; wherein the receiving tray is further configured to receive at least one of: the at least one second game of the second type, or the at least one third game of the third type; at least one hidden internal lock point and at least one hidden internal hinge that are positioned within the gaming terminal apparatus such that a presence of the at least one hidden internal lock point and the at least one internal hinge are not observed nor accessed from an outside of the gaming terminal apparatus; wherein the at least one hidden internal lock and the at least one hidden internal hinge are configured to prevent unauthorized opening of the gaming terminal apparatus; at least one access sensor that is configured to transmit at least one electronic alarm message upon the gaming terminal apparatus being open without prior authorization; at least one communication module that configured to transmit and receive electronic messages related to an operation of the gaming terminal apparatus; wherein the at least one communication module is configured to operationally control an activation and a deactivation of the gaming terminal apparatus upon a receipt of at least one respective electronic message from an electronic device associated with a person controlling the operation of the gaming terminal apparatus.

In some embodiments, the present disclosure provides a method, which includes steps of: manufacturing a gaming terminal apparatus, comprising an accessibility portion, wherein the accessibility portion is positioned at a sufficient distance upward from a bottom of the gaming terminal apparatus to allow a user in a wheelchair to play the at least one first game of the first type, the at least one second game of the second type, and the at least one third game of the third type within the single interactive session, wherein the accessibility portion comprises: an interactive multi-game presenting module that is programmed to display: at least one first interactive graphical user interface that is configured to allow a user to play at least one first game of a first type; at least one second interactive graphical user interface that is configured to allow the user to play at least one second game of a second type; at least one third interactive graphical user interface that is configured to allow the user to play at least one third game of a third type; wherein the interactive multi-game presenting module is programmed to allow the user to play the at least one first game of the first type, the at least one second game of the second type, and the at least one third game of the third type within a single interactive session; wherein the single interactive session comprises a plurality of time-related activities that the gaming terminal apparatus permits a user to perform during a distinct time period; wherein the at least one first game of the first type, the at least one second game of the second type, and the at least one third game of the third type are distinct; wherein at least one of the at least one first game of the first type, the at least one second game of the second type, or the at least one third game of the third type is a game that requires the gaming terminal apparatus to dispense to the user at least one physical game piece or at least one game entry confirmation printout, installing from one to twenty-five bins within the gaming terminal apparatus, wherein each bin of the five to twenty-five bins is configured to house at least one physical game piece corresponding to the at least one first game of the first type, installing a receiving tray within the accessibility portion; wherein the receiving tray is configured to receive, from at least one bin of the five to twenty-five bins, the at least one first game of the first type; wherein the receiving tray is further configured to receive at least one of: the at least one second game of the second type or the at least one third game of the third type; positioning at least one hidden internal lock point and at least one hidden internal hinge within the gaming terminal apparatus such that a presence of the at least one hidden internal lock point and the at least one internal hinge is not observed from an outside of the gaming terminal apparatus; wherein the at least one hidden internal lock point and the at least one hidden internal hinge are configured to prevent unauthorized opening of the gaming terminal apparatus; positioning at least one access sensor within the gaming terminal apparatus, wherein the at least one access sensor is configured to transmit at least one electronic alarm message upon the gaming terminal apparatus being open without prior authorization; positioning at least one communication module within the gaming terminal apparatus, wherein the at least one communication module is configured to transmit and receive electronic messages related to an operation of the gaming terminal apparatus; wherein the at least one communication module is configured to operationally control an activation and a deactivation of the gaming terminal apparatus upon a receipt of at least one respective electronic message from an electronic device associated with a person controlling the operation of the gaming terminal apparatus.

In some embodiments, the at least one first game of the first type is a first instant scratch game and wherein each corresponding physical game piece of the first instant scratch game is each respective first instant scratch game ticket; wherein the at least one second game of the second type a draw-based game; and wherein the at least one third game of the third type is a terminal instant game.

In some embodiments, the gaming terminal apparatus is further configured to automatically update an image representative of the first instant scratch game on the at least one first interactive graphical user interface when the gaming terminal apparatus detects at least one bin of the one to twenty-five bins having a plurality of first instant scratch game tickets.

In some embodiments, the gaming terminal apparatus is further configured to automatically determine a length of each respective first instant scratch game ticket.

In some embodiments, the gaming terminal apparatus is further configured to automatically track sales of instant scratch game tickets.

In some embodiments, the gaming terminal apparatus is further configured to automatically adjust a visual placement of a plurality of instant scratch games on the at least one first interactive graphical user interface based at least in part on the sales of instant scratch game tickets.

In some embodiments, the visual placement of the plurality of instant scratch games on the at least one first interactive graphical user interface is distinct from a physical order of each respective bin of the one to twenty-five bins having respective instant scratch game tickets for each respective instant scratch game of the plurality instant scratch games.

In some embodiments the interactive multi-game presenting module is in the form of a touch-screen.

In some embodiments, the gaming terminal apparatus is in the form of a self-service vending machine.

In some embodiments, the accessibility portion is from 10 inches to 33 inches in height.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIGS. 1-4 show one or more schematic flow diagrams, certain computer-based architectures, and/or screenshots of various specialized graphical user interfaces which are illustrative of some exemplary aspects of at least some embodiments of the present disclosure.

FIGS. 5-11 show various views of a gaming terminal apparatus according to the present disclosure.

FIG. 12 depicts an exemplary gaming terminal apparatus according to the present disclosure, which includes an accessibility portion, which accommodates an individual in a wheelchair.

FIG. 13 depicts exemplary screenshots of a graphical user interface (“GUI”) according to the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

As defined herein, “accessibility portion” is a portion of a gaming terminal apparatus which is configured to be interacted with by a user in a wheelchair (“a wheelchair bound user”).

In some embodiments, exemplary inventive, specially programmed computing systems/platforms with associated devices, such as the one or more gaming terminal apparatuses of the present disclosure, are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes. In some embodiments, the NFC can represent a short-range wireless communications technology in which NFC-enabled devices, such as the one or more gaming terminal apparatuses of the present disclosure, are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In some embodiments, a machine-readable medium can be associated with one or more gaming terminal apparatuses.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth. In some embodiments, one or all of the above hardware elements may be incorporated into one or more gaming terminal apparatuses.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints. In some embodiments, one or more gaming terminal apparatuses of the present disclosure, can be configured to run the above software.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices (such as one or more gaming terminal apparatuses), and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, gaming terminal apparatus, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of exemplary inventive computer-based systems/platforms, exemplary inventive computer-based devices (such as one or more gaming terminal apparatuses), and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a tweet, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to:

1) AmigaOS, AmigaOS 4

2) FreeBSD, NetBSD, OpenBSD

3) Linux

4) Microsoft Windows

5) OpenVMS

6) OS X (Mac OS)

7) OS/2

8) Solaris

9) Tru64 UNIX

10) VM

11) Android

12) Bada

13) BlackBerry OS

14) Firefox OS

15) iOS

16) Embedded Linux

17) Palm OS

18) Symbian

19) Tizen

20) WebOS

21) Windows Mobile

22) Windows Phone

23) Adobe AIR

24) Adobe Flash

25) Adobe Shockwave

26) Binary Runtime Environment for Wireless (BREW)

27) Cocoa (API)

28) Cocoa Touch

29) Java Platforms

30) JavaFX

31) JavaFX Mobile

32) Microsoft XNA

33) Mono

34) Mozilla Prism, XUL and XULRunner

35) .NET Framework

36) Silverlight

37) Open Web Platform

38) Oracle Database

39) Qt

40) SAP NetWeaver

41) Smartface

42) Vexi, and

43) Windows Runtime.

In some embodiments, exemplary inventive computer-based systems/platforms, exemplary inventive computer-based devices (such as one or more gaming terminal apparatuses), and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application.

For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices (such as the one or more gaming terminal apparatuses of the present disclosure), and/or exemplary inventive computer-based components of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-10,000,000,000).

In some embodiments, exemplary inventive computer-based systems/platforms, exemplary inventive computer-based devices (such as the one or more gaming terminal apparatuses of the present disclosure), and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices (such as the one or more gaming terminal apparatuses of the present disclosure), and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “proximity detection,” “locating,” “location data,” “location information,” and “location tracking” refer to any form of location tracking technology or locating method that can be used to provide a location of, for example, a particular computing device/system/platform of the present disclosure and/or any associated computing devices, based at least in part on one or more of the following techniques/devices, without limitation: accelerometer(s), gyroscope(s), Global Positioning Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the exemplary inventive computer-based systems/platforms, the exemplary inventive computer-based devices (such as the one or more gaming terminal apparatuses of the present disclosure), and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RCS, CAST and Skipjack), cryptographic hash algorithms (e.g., MD5, RIPEMD-160, RTRO, SHA-1, SHA-2, Tiger (TTH), WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

In some embodiments, the present disclosure is directed to an apparatus. In some embodiments, the apparatus is a gaming terminal apparatus. In some embodiments, the apparatus takes the form of an instant ticket vending machine. In some embodiments, the present disclosure is directed to systems, methods, and apparatuses for purchasing unlimited draw based games, terminal instants and instant scratch tickets. Some embodiments aim to attract lottery players when on a regular shopping trip to retail stores and build on impulse buy occasion.

In some embodiments, the tickets can be instant scratch tickets, draw based game tickets, and/or terminal instants. In some embodiments, the apparatus is configured to dispense 2 to 50 tickets per user. In some embodiments, the apparatus is configured to dispense 5 to 50 tickets per user. In some embodiments, the apparatus is configured to dispense 10 to 50 tickets per user. In some embodiments, the apparatus is configured to dispense 25 to 50 tickets per user. In some embodiments, the apparatus is configured to dispense 40 to 50 tickets per user. In some embodiments, the apparatus is configured to dispense 45 to 50 tickets per user.

In some embodiments, the apparatus can have a height ranging from 10 to 60 inches. In some embodiments, the apparatus can have a height ranging from 20 to 60 inches. In some embodiments, the apparatus can have a height ranging from 30 to 60 inches. In some embodiments, the apparatus can have a height ranging from 40 to 60 inches. In some embodiments, the apparatus can have a height ranging from 50 to 60 inches. In some embodiments, the apparatus can have a height ranging from 55 to 60 inches.

In some embodiments, the apparatus may include an advertisement and promotion lottery module with programmable multimedia content and call-to-action material for a user (e.g., information, how-to-play instructions, drawing dates and times, jackpot results, etc.).

In some embodiments, the apparatus may be configured to accommodate the trend of increasingly open floor plans within retail outlets and big stores. In some embodiments, the apparatus may be configured to have a size and capacity, which allows one or more users to view the apparatus from the front end and/or checkout area of a standard supercenter store.

In some embodiments, the apparatus is configured to house from 5 to 25 bins, wherein each bin is configured to house a predetermined number of scratch tickets. In some embodiments, the apparatus is configured to house from 10 to 25 bins, wherein each bin is configured to house a predetermined number of scratch tickets. In some embodiments, the apparatus is configured to house from 15 to 25 bins, wherein each bin is configured to house a predetermined number of scratch tickets. In some embodiments, the apparatus is configured to house from 20 to 25 bins, wherein each bin is configured to house a predetermined number of scratch tickets. In some embodiments, the apparatus is configured to house from 5 to 20 bins, wherein each bin is configured to house a predetermined number of scratch tickets. In some embodiments, the apparatus is configured to house from 5 to 15 bins, wherein each bin is configured to house a predetermined number of scratch tickets. In some embodiments, the apparatus is configured to house from 5 to 10 bins, wherein each bin is configured to house a predetermined number of scratch tickets. In some embodiments, the apparatus is configured to house from 10 to 20 bins, wherein each bin is configured to house a predetermined number of scratch tickets. In some embodiments, the apparatus is configured to house from 15 to 20 bins, wherein each bin is configured to house a predetermined number of scratch tickets. In some embodiments, the apparatus is configured to house from 10 to 15 bins, wherein each bin is configured to house a predetermined number of scratch tickets.

In some embodiments, the apparatus is configured to allow a user to play at least one game. In some embodiments, the apparatus is configured to allow a user to play at least two games. In some embodiments, the apparatus is configured to allow a user to play at least three games. In some embodiments, the apparatus is configured to allow a user to play at least five games. In some embodiments, the apparatus is configured to allow a user to play at least ten games. In some embodiments, the apparatus is configured to allow a user to play at least twenty games. In some embodiments, the apparatus is configured to allow a user to play at least twenty-five games.

In some embodiments, the apparatus comprises at least one Graphical User Interface (“GUI”). In some embodiments, the least one GUI s configured to display at least one of: a plurality of instant scratch ticket, a plurality of draw-based games, or a plurality of terminal instants. In some embodiments, the at least one GUI includes at least one access page. In some embodiments, the at least one GUI is in the form of a “lobby” or “home page.” In some embodiments, the “lobby” or “home page” is configured to provide continuously updated information (e.g., via communication with one or more servers, as described herein). In some embodiments, the continuously updated information can include time winning columns and jackpots for numerical games. In some embodiments, the continuously updated information can be integrated into a CMS/Digital Signage System.

In some embodiments, the at least one GUI is configured to transform into a centrally managed digital signage display when integrated to a CMS/Digital Signage System. In some embodiments, the at least one GUI is configured to present high definition multimedia content. In some embodiments, the high definition multimedia content can include, but is not limited to: promotional messages and commercial advertising; game demos and trailers; and social alerts, such as: amber alerts, weather information, social responsibility messages, etc.

In some embodiments, the apparatus is in the form of a vending machine that includes at least the following components: a housing, having a footprint defined by a length and a width; a X number of dispensing combinations; where each dispensing combination is operationally installed within an interior of the housing; where the X number is determined based, at least in part, on at least one of the length and the width of the footprint of the housing; where each dispensing combination includes: a holding tray; where each holding tray has a first side and a second side; where the first side is opposite of the second side; where the holding tray is configured to slide in and out of the vending machine; a first plurality of pockets; where the first plurality of pockets are positioned at the first side of the holding tray; where the first plurality of pockets is configured to hold a first plurality of dispensing objects; a first separation mechanism; where the first separation mechanism is operationally connected to the holding tray and the first plurality of pockets; where the first separation mechanism is configured to separate each dispensing object only from the first plurality of dispensing objects when the first plurality of dispensing objected are dispensed from the first plurality of pockets; a second plurality of pockets; where the second plurality of pockets are positioned at the second side of the holding tray; where the second plurality of pockets is configured to hold a second plurality of dispensing objects; a second separation mechanism; where the second separation mechanism is operationally connected to the holding tray and the second plurality of pockets; where the second separation mechanism is configured to separate each dispensing object only from the second plurality of dispensing objects when the second plurality of dispensing objected are dispensed from the second plurality of pockets. In some embodiments, the vending machine is a stand-alone vending machine. In some embodiments, the vending machine includes 5 trays and 5 pockets per tray for a total of 25 bins. In some embodiments, each bin is configured to house a predetermined number of physical game pieces. Other exemplary embodiments of vending machines in accordance with the present disclosure are described in WIPO Publication No. WO/2014199238, which is incorporated by reference herein in its entirety. In some embodiments, the vending machine is configured to minimize events of jamming, providing a smooth experience for a user.

In some embodiments, the GUI takes the form of a touch-screen. In some embodiments, the touch-screen is a 32″ Full-HD touch monitor, providing a landscape orientation for online games and scratch tickets. In some embodiments, the GUI can comprise one or more of the following features: Ergonomic inclination; Draw/Lotto Games and EZ Play™/Fast Play™ Quick Picks, Content and Graphics capability; 1920×1080 resolution; HDMI video connection; PCAP USB touchscreen capability, SAW touchscreen capability; or ball drop resistance.

In some embodiments, the apparatus further comprises an internal touchscreen. In some embodiments, the internal touchscreen is a 10.1″ portrait touchscreen. In some embodiments, the internal touchscreen is only accessible from the retailer when a main door is opened. In some embodiments, the internal touchscreen comprises one or more of the following features: A diagnostics menu, a HDMI, 800×1280 resolution, a SAW touchscreen capability, or a PCAP USB touchscreen capability.

In some embodiments, the apparatus is configured to house a high speed, large roll thermal ticket/receipt printer. In some embodiments, the apparatus is configured to house and/or print a paper roll of up to 200 mm in diameter.

In some embodiments, the apparatus comprises an industry standard bill acceptor. In some embodiments, the bill acceptor is housed in a separate locked vault.

In some embodiments, the apparatus comprises a barcode reader. In some embodiments, the barcode reader is a 2-D barcode reader. In some embodiments, the barcode reader allows for easy and quick loading of tickets. In some embodiments, the loading of tickets is configured to be performed internally by a retailer. In some embodiments, the barcode reader also functions as a ticket checker, which is configured to permit a user to validate a ticket, a voucher, or both. In some embodiments, at least one of: the ticket or the voucher is printed on paper. In some embodiments, at least one of the ticket or the voucher is printed on paper. In some embodiments, at least one of the ticket or the voucher is printed on a user's screen, such as the screen of a smartphone or a tablet.

In some embodiments, the apparatus comprises a playslip scanner. In some embodiments, the playslip scanner is configured to provide a user an opportunity to self-select lottery numbers.

In some embodiments, the apparatus comprises a cashless payment device configured to allow cashless payments. In some embodiments, the cashless payment comprises at least one of: credit card payments, debit card payments, Venmo™, Paypal™, Chase Quick Pay™, Apple Pay™, and the like.

In some embodiments, the apparatus comprises a receiving tray, such as a ticket receiving tray. In some embodiments, the receiving tray is color-illuminated and thus configured to provide an alert notification upon delivery of a ticket.

In some embodiments, the apparatus is configured to be activated and/or deactivated with a remote control. In some embodiments, a retailer can activate and/or deactivate the apparatus from a distance to prevent underage use.

In some embodiments, the apparatus can comprise an uninterruptible power supply (“UPS”), so that pending transactions can be completed in case of a power outage.

In some embodiments, the apparatus comprises at least one of: audio support; a TCP/IP network connection; a plurality (e.g., four) of support points on the back of a cabinet portions for mounting a router (e.g., a 3G/4G/5G router); an external auxiliary AC outlet configured to connect additional devices next to the apparatus, so as to minimize multiple cables a on floor plan; an electronic ID to provide unique identification of a particular apparatus; a customized full wrap graphic exterior design; or cable routing options with covers and a predetermined number of sides (e.g., three sides).

In some embodiments the apparatus can comprise a cabinet. In some embodiments, the cabinet can be a metal cabinet. In some embodiments, the metal cabinet can be constructed from cold rolled steel. In some embodiments, the cabinet can be painted with a durable powder coating. In some embodiments, the cabinet can comprise a reinforced door with a safety lock. In some embodiments, the cabinet can comprise a “hidden” hinge along a full length of the door. In some embodiments, the cabinet can comprise a locking point on the door. In some embodiments, the locking point can be a 6-anchor locking point. In some embodiments, the locking point is not accessible or visible from a vantage point outside the cabinet. In some embodiments, the cabinet can comprise an electronic sensor on the main door, wherein the electronic sensor is configured to notify a retailer of door accesses. In some embodiments, the cabinet comprises at least one stainless steel lock with a unique key.

In some embodiments, the apparatus comprises an embedded alarm siren, which is configured to be activated in the event of vandalism, tilting of the apparatus, or unauthorized door access. In some embodiments, the apparatus comprises a remote siren, which is configured to be activated to prevent abuse/theft from a secure distance. In some embodiments, a main door of the apparatus comprises a hidden hinge. In some embodiments, the apparatus comprises a door with a handle to facilitate easy door opening. In some embodiments, the apparatus comprises leveling adjustable feet. In some embodiments, the apparatus comprises four transportation wheels. In some embodiments, the apparatus comprises three transportation wheels. In some embodiments, the apparatus comprises two transportation wheels.

In some embodiments, the GUI comprises a player main menu. In some embodiments, the GUI is configured to provide a landscape main menu configured to display and sell from 1 to 25 scratch tickets. In some embodiments, the GUI is configured to provide a landscape main menu configured to display and sell from 5 to 25 scratch tickets. In some embodiments, the GUI is configured to provide a landscape main menu configured to display and sell from 10 to 25 scratch tickets. In some embodiments, the GUI is configured to provide a landscape main menu configured to display and sell from 15 to 25 scratch tickets. In some embodiments, the GUI is configured to provide a landscape main menu configured to display and sell from 20 to 25 scratch tickets.

In some embodiments, the GUI is configured to display and sell any type and number of draw based game and terminal instant through a touch-screen interface. In some embodiments, the GUI is configured to provide a number of games by Quick Pick, by Full Board, or via play slip. In some embodiments, the GUI is configured to display a balance of a user. In some embodiments, the GUI is configured to display instruction messages (i.e., “Insert Money to Play”). In some embodiments, the GUI is configured to display advertising or promotional messaging directed to the user. In some embodiments, the GUI is configured to show when a scratch ticket is out of stock, such that an “OUT” symbol will appear on the icon of the specific scratch ticket. In some embodiments, the GUI is configured to display popup window messages for draw games, U-pick boards, checking of winnings, error notifications, etc.

In some embodiments, the GUI comprises an “idle mode.” In some embodiments, when in idle mode, the GUI can display gaming information, how-to-play instructions, drawing dates/times, jackpot results, in-store promotional campaigns, and 3^{rd} party commercial advertising.

In some embodiments, the GUI is configured to display information in landscape full-screen format. In some embodiments, the GUI is compatible with Canvas Digital Signage (HORIZON) and is centrally managed per terminal/group/region/country.

In some embodiments, the cabinet of the apparatus comprises a dedicated retailer menu. In some embodiments, the dedicated retailer menu is configured to be displayed on a 10.1″ touch monitor. In some embodiments, the retailer menu permits a retail user to log in with a user name and password in one or more of the following modes: Retailer Manager, Retailer Clerk, LSR, CST, or Administrator. In some embodiments, the retailer menu includes one or more of the following menu options: Maintenance Operations; Financial Reports; Pack Settlement; Scratch Pays; Current Weekly Invoice; Terminal Operations; System Reports; Diagnostics; or Terminal.

In some embodiments, the apparatus permits age verification through driver's license, I.D. card or players card reading. In some embodiments, the apparatus permits automatic loading of an IT image on a front screen upon loading a bin with a new scratch ticket. In some embodiments, the apparatus permits ticket activation, settlement, and receiving orders. In some embodiments, the apparatus permits a user to load and unload scratch ticket packs, select a bin, specify ticket length, apply or cancel, or select a number of tickets to be displayed by a selected bin.

In some embodiments, the apparatus comprises a ticket dispenser assembly. In some embodiments, the ticket dispenser assembly comprises from 5 to 25 bins. In some embodiments, the ticket dispenser assembly comprises from 10 to 25 bins. In some embodiments, the ticket dispenser assembly comprises from 15 to 25 bins. In some embodiments, the ticket dispenser assembly comprises from 20 to 25 bins.

In some embodiments, the ticket dispenser assembly comprises from 1 to 5 drawers. In some embodiments, the ticket dispenser assembly comprises from 2 to 5 drawers. In some embodiments, the ticket dispenser assembly comprises from 3 to 5 drawers. In some embodiments, the ticket dispenser assembly comprises from 4 to 5 drawers.

In some embodiments, the ticket dispenser assembly is configured to dispense tickets from 2 to 12 inches in length. In some embodiments, the ticket dispenser assembly is configured to dispense tickets from 3 to 10 inches in length. In some embodiments, the ticket dispenser assembly is configured to dispense tickets from 4 to 8 inches in length. In some embodiments, the ticket dispenser assembly is configured to dispense tickets from 5 to 6 inches in length.

In some embodiments, game parameters for each active scratch game are configured to be stored on a local, network, or cloud storage unit. In some embodiments the game parameters comprise one or more of: ticket length, pack size, or ticket price. In some embodiments ticket length of a pack being loaded into a bin can be automatically set by software. In some embodiments, there is no need for a retailer to set ticket length because the ticket length can be retrieved by a control-system at sign on. In some embodiments, there is an option to reacquire tickets (e.g., under a menu item “Diagnostics→Update Instant Ticket Database”).

In some embodiments, the apparatus can be configured to provide one or more message notification alerts. In some embodiments, the notification alerts can comprise “Bin-low,” “Bin-out,” or “Auto Message” notification alerts.

In some embodiments, the apparatus can be configured to provide one or more instant ticket inventory functions, such as “Receive Shipment,” “Pack Activation,” or “Pack Settlement.”

In some embodiments, the apparatus provides timer functionality that is configured automatically place the apparatus into sleep mode (e.g., outside of working hours, or as otherwise designated based on time settings). In some embodiments, the apparatus is set to “no wagering” and “bill acceptor off” while a message on the screen informs the customers that equipment is unavailable. If necessary, the default timer can be modified to a different operation schedule.

In some embodiments, the apparatus is set to a central system and is configured to output variety reports. In some embodiments, the reports can correspond to data from the following, non-exhaustive list: summary/total for the draw sales, instant/scratch sales, Redemptions/Validations, Promotional Sum, Cash, Credit, Debit, etc. In some embodiments, one single barcode includes a summary of “Closed shift report” data. This data can be output, e.g., once per day at the end of each shift before midnight.

In some embodiments, retail sales managers, customer service manager and other retail personnel can be notified in case a product category is reaching the “out of stock” levels by alert notification on a mobile device. In some embodiments, the apparatus can include a full color LED light sign. In some embodiments, the full color LED light sign is disposed at a top portion of the terminal. In some embodiments, the LED light sign is configured to inform retail personnel of stock status by one or more color codes. In cases of low and out of stock of, for example, paper on printer and scratch tickets on bins, retail personnel can get informed visually, by seeing light signs in different color coding, indicating the nature of each situation.

In some embodiments, the apparatus may be configured to provide shopping cart functionality for players to add/verify or remove purchased items, when using bank card and cashless payment where available, cash payment or other payment methods.

In some embodiments, the apparatus may be configured to provide planogram guidelines for product placement on main menu display. This can allow the apparatus to track its own sales of tickets. This can further allow the apparatus to generate suggestions on a planogram for automatic sorting according to rules like store sales, price point, and the like.

In some embodiments, the present disclosure is directed to a gaming terminal apparatus. In some embodiments, the gaming terminal apparatus comprises an interactive multi-game presenting module that is programmed to display: at least one first interactive graphical user interface that is configured to allow a user to play at least one first game of a first type; at least one second interactive graphical user interface that is configured to allow the user to play at least one second game of a second type; and at least one third interactive graphical user interface that is configured to allow the user to play at least one third game of a third type. In some embodiments, the at least one first game of the first type, the at least one second game of the second type, and the at least one third game of the third type are distinct. In some embodiments, the at least one first game of the first type, the at least one second game of the second type, and the at least one third game of the third type are the same. In some embodiments, the gaming terminal apparatus is in the form of a self-service vending machine.

Some embodiments of the present disclosure are directed to a method of manufacturing a gaming terminal apparatus, comprising: an interactive multi-game presenting module that is programmed to display; at least one first interactive graphical user interface that is configured to allow a user to play at least one first game of a first type; at least one second interactive graphical user interface that is configured to allow the user to play at least one second game of a second type; at least one third interactive graphical user interface that is configured to allow the user to play at least one third game of a third type. In some embodiments, the method comprises installing from five to twenty-five bins within the gaming terminal apparatus. In some embodiments, the method comprises positioning at least one hidden internal lock point and at least one internal hinge within the gaming terminal apparatus such that a presence of the at least one hidden internal lock point and the at least one internal hinge are not observed nor accessed from an outside of the gaming terminal apparatus. In some embodiments, the method comprises positioning at least one access sensor within the gaming terminal apparatus. In some embodiments, the method comprises positioning at least one communication module within the gaming terminal apparatus, wherein the at least one communication module is configured to transmit and receive electronic messages related to an operation of the gaming terminal apparatus. In some embodiments, the method comprises a step of installing a receiving tray.

In some embodiments, the interactive multi-game presenting module is programmed to allow the user to play the at least one first game of the first type, the at least one second game of the second type, and the at least one third game of the third type within a single interactive session. In some embodiments, the single interactive session comprises a plurality of time-related activities that the gaming terminal apparatus permits a user to perform during a distinct time period. In some embodiments, the interactive multi-game presenting module is in the form of a touch-screen.

In some embodiments, at least one of the at least one first game of the first type, the at least one second game of the second type, or the at least one third game of the third type is a game that requires the gaming terminal apparatus to dispense to the user at least one physical game piece, or at least one game entry confirmation printout.

In some embodiments, the gaming terminal apparatus comprises from five to twenty-five bins. In some embodiments, the gaming terminal apparatus comprises from ten to twenty-five bins. In some embodiments, the gaming terminal apparatus comprises from fifteen to twenty-five bins. In some embodiments, the gaming terminal apparatus comprises from twenty to twenty-five bins. In some embodiments, each bin is configured to house at least one physical game piece corresponding to at least one first game of the first type. In some embodiments, each bin is housed inside the gaming terminal apparatus.

In some embodiments, the gaming terminal apparatus includes at least one hidden internal lock point and at least one hidden internal hinge that is positioned within the gaming terminal apparatus such that a presence of the at least one hidden internal lock point and the at least one hidden internal hinge are not observed nor accessed from an outside of the gaming terminal apparatus. In some embodiments, the at least one hidden internal lock point and hidden internal hinge are configured to prevent unauthorized opening of the gaming terminal apparatus.

In some embodiments, the gaming terminal apparatus includes at least one access sensor that is configured to transmit at least one electronic alarm message upon the gaming terminal apparatus being open without prior authorization.

In some embodiments, the gaming terminal apparatus includes at least one communication module that configured to transmit and receive electronic messages related to an operation of the gaming terminal apparatus. In some embodiments, the at least one communication module is configured to operationally control an activation and a deactivation of the gaming terminal apparatus upon a receipt of at least one respective electronic message from an electronic device associated with a person controlling the operation of the gaming terminal apparatus. In some embodiments, the electronic device is a key fob. In some embodiments, the electronic device is a remote control.

In some embodiments, the at least one first game of the first type is a first instant scratch game and wherein each corresponding physical game piece of the first instant scratch game is each respective first instant scratch game ticket. In some embodiments, the at least one second game of the second type a draw-based game and the at least one third game of the third type is a terminal instant game. In some embodiments, the gaming terminal apparatus is further configured to automatically update an image representative of the first instant scratch game on the at least one first interactive graphical user interface when the gaming terminal apparatus detects at least one bin of the one to twenty-five bins having a plurality of first instant scratch game tickets. In some embodiments, the gaming terminal apparatus is further configured to automatically determine a length of each respective first instant scratch game ticket. In some embodiments, the gaming terminal apparatus is further configured to automatically track sales of instant scratch game tickets.

In some embodiments, the gaming terminal apparatus is further configured to automatically activate each respective pack of instant scratch game tickets before dispensing each respective first instant scratch game ticket to the user.

In some embodiments, the gaming terminal apparatus comprises a receiving tray. In some embodiments, the receiving tray is configured to receive, from at least one bin of the one to twenty-five bins the at least one first game of the first type. In some embodiments, the receiving tray is configured to receive at least one of: the at least one second game of the second type, or the at least one third game of the third type. In some embodiments, the receiving tray is configured to receive at least one of: the at least one second game of the second type, or the at least one third game of the third type from a printer. In some embodiments, the printer is a thermal printer.

In some embodiments, the gaming terminal apparatus is configured such that the accessibility portion is positioned at a sufficient distance upward from a bottom of the gaming terminal apparatus to allow a user in a wheelchair to play the at least one first game of the first type, the at least one second game of the second type, and the at least one third game of the third type within the single interactive session. In some embodiments, the accessibility portion includes the interactive-multi-game presenting module and a receiving tray. In some embodiments, the accessibility portion also includes one or more bill collectors, one or more bar-code readers, one or more play-slip scanners, one or more cashless payment apparatuses, among other interactive components.

In some embodiments, the sufficient distance upward is from 5 to 15 inches. In some embodiments, the sufficient distance upward is from 6 to 10 inches. In some embodiments, the sufficient distance upward is 7 to 8 inches.

In some embodiments, the sufficient distance upward is from 5 to 10 inches. In some embodiments, the sufficient distance upward is from 5 to 8 inches. In some embodiments, the sufficient distance upward is from 5 to 7 inches. In some embodiments, the sufficient distance upward is from 5 to 6 inches.

In some embodiments, the sufficient distance upward is from 6 to 15 inches. In some embodiments, the sufficient distance upward is from 7 to 15 inches. In some embodiments, the sufficient distance upward is from 8 to 15 inches. In some embodiments, the sufficient distance upward is from 10 to 15 inches.

In some embodiments, a height of the accessibility portion ranges from 10 inches to 33 inches so as to allow a user in a wheelchair to play the at least one first game of the first type, the at least one second game of the second type, and the at least one third game of the third type within the single interactive session. In some embodiments, a height of the accessibility portion ranges from 15 inches to 28 inches so as to allow a user in a wheelchair to play the at least one first game of the first type, the at least one second game of the second type, and the at least one third game of the third type within the single interactive session. In some embodiments, a height of the accessibility portion ranges from 20 inches to 23 inches so as to allow a user in a wheelchair to play the at least one first game of the first type, the at least one second game of the second type, and the at least one third game of the third type within the single interactive session.

In some embodiments, the gaming terminal apparatus is from 15 inches to 60 inches in height, so as to allow a user in a wheelchair to play the at least one first game of the first type, the at least one second game of the second type, and the at least one third game of the third type within the single interactive session. In some embodiments, the gaming terminal apparatus is from 18 inches to 54 inches in height, so as to allow a user in a wheelchair to play the at least one first game of the first type, the at least one second game of the second type, and the at least one third game of the third type within the single interactive session. In some embodiments, the gaming terminal apparatus is from 24 inches to 48 inches in height, so as to allow a user in a wheelchair to play the at least one first game of the first type, the at least one second game of the second type, and the at least one third game of the third type within the single interactive session. In some embodiments, the gaming terminal apparatus is from 30 inches to 42 inches in height, so as to allow a user in a wheelchair to play the at least one first game of the first type, the at least one second game of the second type, and the at least one third game of the third type within the single interactive session. In some embodiments, the wherein the gaming terminal apparatus is from 30 inches to 42 inches in height, so as to allow a user in a wheelchair to play the at least one first game of the first type, the at least one second game of the second type, and the at least one third game of the third type within the single interactive session.

In some embodiments, the gaming terminal apparatus is a self-service vending machine of up to 60 inches in height. In some embodiments, the gaming terminal apparatus is a self-service vending machine of up to 54 inches in height. In some embodiments, the gaming terminal apparatus is a self-service vending machine of up to 48 inches in height.

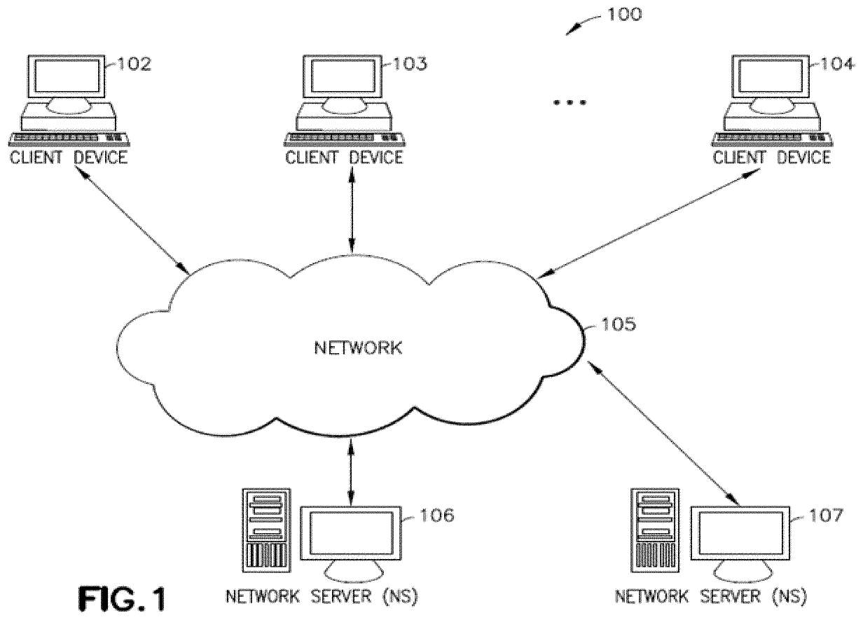

FIG.1 depicts a block diagram of an exemplary computer-based system/platform 100 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 100 may be configured to manage a large number of members and/or concurrent transactions, as detailed herein. In some embodiments, the exemplary computer-based system/platform 100 may be based on a scalable computer and/or network architecture that incorporates varies strategies for assessing the data, caching, searching, and/or database connection pooling. An example of the scalable architecture is an architecture that is capable of operating multiple servers.

In some embodiments, referring to FIG. 1, members 102-104 (e.g., clients) of the exemplary computer-based system/platform 100 may include virtually any computing device capable of receiving and sending a message over a network (e.g., cloud network), such as network 105, to and from another computing device, such as servers 106 and 107, each other, and the like. In some embodiments, the member devices 102-104 may be personal computers, multiprocessor systems, microprocessor-based or programmable consumer electronics, network PCs, gaming terminal apparatuses and the like. In some embodiments, one or more member devices within member devices 102-104 may include computing devices that typically connect using a wireless communications medium such as cell phones, smart phones, pagers, walkie talkies, radio frequency (RF) devices, infrared (IR) devices, CBs, integrated devices combining one or more of the preceding devices, gaming terminal apparatuses, or virtually any mobile computing device, and the like. In some embodiments, one or more member devices within member devices 102-104 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), a gaming terminal apparatus and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 102-104 may include may run one or more applications, such as Internet browsers, mobile applications, voice calls, video games, videoconferencing, and email, among others. In some embodiments, one or more member devices within member devices 102-104 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 102-104 may be specifically programmed by either Java, .Net, QT, C, C++ and/or other suitable programming language. In some embodiments, one or more member devices within member devices 102-104 may be specifically programmed include or execute an application to perform a variety of possible tasks, such as, without limitation, messaging functionality, browsing, searching, playing, streaming or displaying various forms of content such as lottery games, including locally stored or uploaded messages, images and/or video, and/or games.

In some embodiments, the exemplary network 105 may provide network access, data transport and/or other services to any computing device coupled to it. In some embodiments, the exemplary network 105 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 105 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 105 may include and implement, as an alternative or in conjunction with one or more of the above, a WiMAX architecture defined by the WiMAX forum. In some embodiments and, optionally, in combination of any embodiment described above or below, the exemplary network 105 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 105 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 105 may also include mass storage, such as network attached storage (NAS), a storage area network (SAN), a content delivery network (CDN) or other forms of computer or machine readable media.

In some embodiments, the exemplary server 106 or the exemplary server 107 may be a web server (or a series of servers) running a network operating system, examples of which may include but are not limited to Microsoft Windows Server, Novell NetWare, or Linux. In some embodiments, the exemplary server 106 or the exemplary server 107 may be used for and/or provide cloud and/or network computing. Although not shown in FIG. 1, in some embodiments, the exemplary server 106 or the exemplary server 107 may have connections to external systems like email, SMS messaging, text messaging, ad content providers, etc. Any of the features of the exemplary server 106 may be also implemented in the exemplary server 107 and vice versa.

In some embodiments, one or more of the exemplary servers 106 and 107 may be specifically programmed to perform, in non-limiting example, as authentication servers, search servers, email servers, social networking services servers, SMS servers, IM servers, MMS servers, exchange servers, photo-sharing services servers, advertisement providing servers, lottery servers, financial/banking-related services servers, travel services servers, or any similarly suitable service-base servers for users of the member computing devices 101-104, which can comprise gaming terminal apparatuses.

In some embodiments and, optionally, in combination of any embodiment described above or below, for example, one or more exemplary computing member devices 102-104, the exemplary server 106, and/or the exemplary server 107 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof

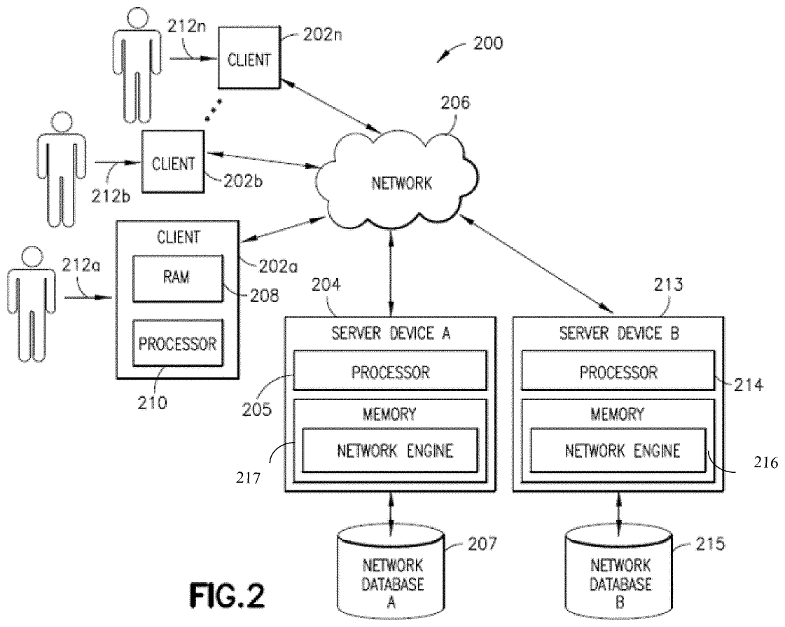

FIG. 2 depicts a block diagram of another exemplary computer-based system/platform 200 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 202a, 202b thru 202n shown each at least includes a computer-readable medium, such as a random-access memory (RAM) 208 coupled to a processor 210 or FLASH memory. In some embodiments, the processor 210 may execute computer-executable program instructions stored in memory 208. In some embodiments, the processor 210 may include a microprocessor, an ASIC, and/or a state machine. In some embodiments, the processor 210 may include, or may be in communication with, media, for example computer-readable media, which stores instructions that, when executed by the processor 210, may cause the processor 210 to perform one or more steps described herein. In some embodiments, examples of computer-readable media may include, but are not limited to, an electronic, optical, magnetic, or other storage or transmission device capable of providing a processor, such as the processor 210 of client 202a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 202a-n may also comprise a number of external or internal devices such as a mouse, a CD-ROM, DVD, a physical or virtual keyboard, a display, or other input or output devices. In some embodiments, examples of member computing devices 202a-n (e.g., clients) may be any type of processor-based platforms that are connected to a network 206 such as, without limitation, personal computers, digital assistants, gaming terminal apparatuses, personal digital assistants, smart phones, pagers, digital tablets, laptop computers, Internet appliances, and other processor-based devices. In some embodiments, member computing devices 202a-n may be specifically programmed with one or more application programs in accordance with one or more principles/methodologies detailed herein. In some embodiments, member computing devices 202a-n may operate on any operating system capable of supporting a browser or browser-enabled application, such as Microsoft™, Windows™, and/or Linux. In some embodiments, member computing devices 202a-n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 202a-n, users, 212a-n, may communicate over the exemplary network 206 with each other and/or with other systems and/or devices coupled to the network 206. As shown in FIG. 2, exemplary server devices 204 and 213 may be also coupled to the network 206. In some embodiments, one or more member computing devices 202a-n may be mobile clients. In some embodiments, member computing devices 202a-n shown may include one or more gaming terminal apparatuses.

In some embodiments, at least one database of exemplary databases 207 and 215 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

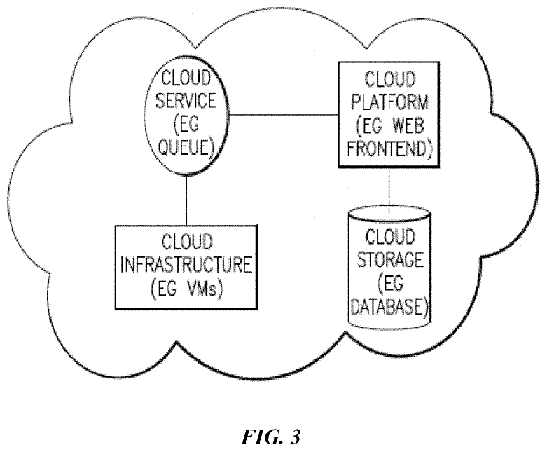

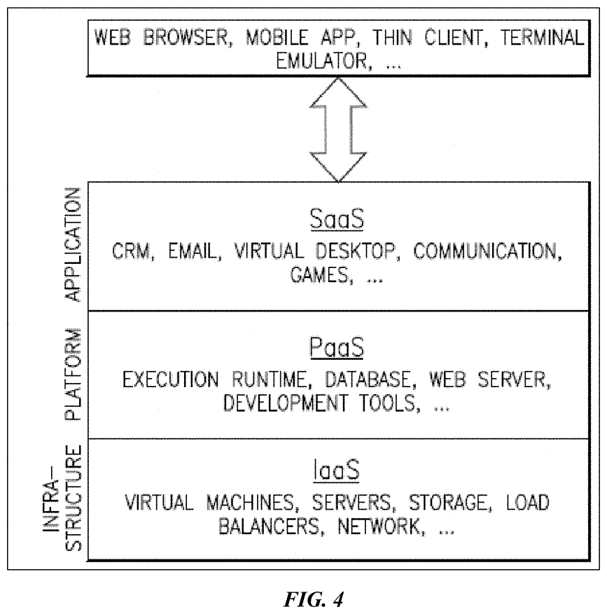

In some embodiments, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS), platform as a service (PaaS), and/or software as a service (SaaS). FIGS. 3 and 4 illustrate schematics of exemplary implementations of the cloud computing/architecture(s) in which the exemplary inventive computer-based systems/platforms, the exemplary inventive computer-based devices (e.g., the gaming terminal apparatuses described herein), and/or the exemplary inventive computer-based components of the present disclosure may be specifically configured to operate.

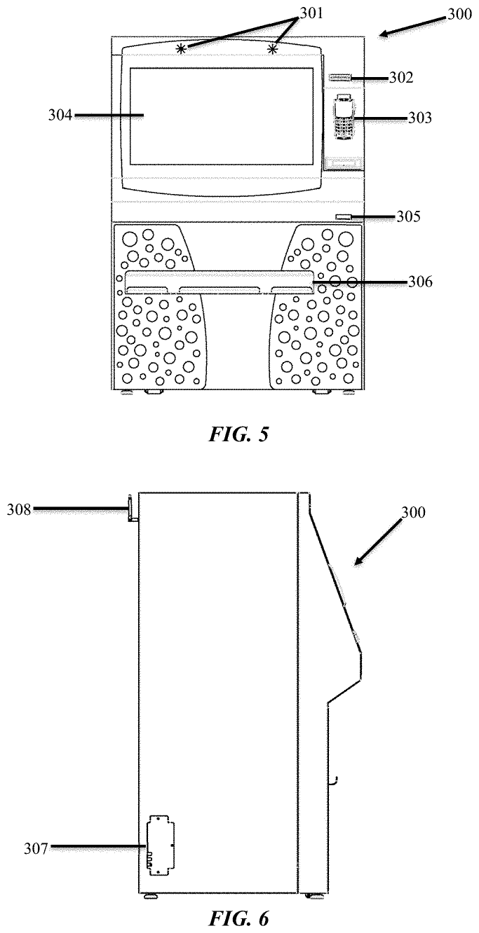

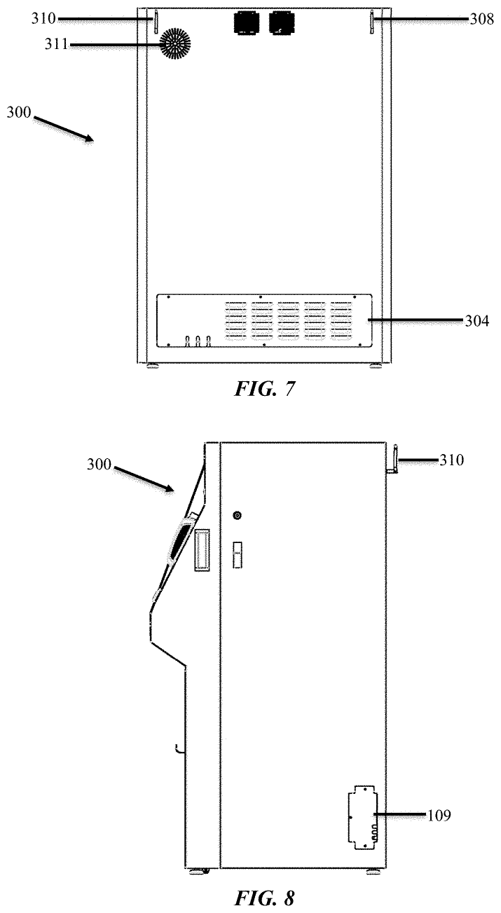

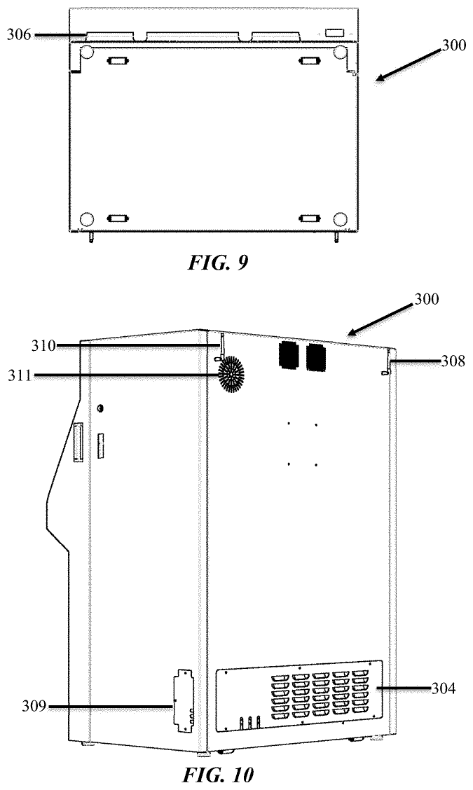

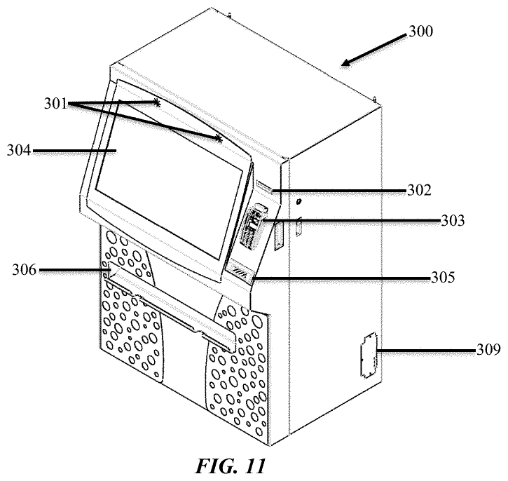

FIGS. 5-11 show various views of a gaming terminal apparatus according to the present disclosure. As shown, in some embodiments, an exemplary gaming terminal apparatus 300 can comprise one or more speakers 301, which can be configured to output audio. In some embodiments, the gaming terminal apparatus 300 can further include bill acceptor 302, which can include a currency validator configured to detect and validate various global currencies. In some embodiments, gaming terminal apparatus 300 can include a cashless payment device 303 configured to permit user payments, e.g., by Venmo™, Paypal™, Chase Quick Pay™, Apple Pay™, and the like.

In some embodiments, the cashless payment device 303 is configured to work in conjunction with a mobile device. In some embodiments, gaming terminal apparatus 300 can include a graphical user interface (“GUI”) 304. In some embodiments, GUI 304 takes the form of a touchscreen. In some embodiments, gaming terminal apparatus 300 can include barcode reader 305, which is configured to read lottery tickets, and in some embodiments, validate lottery tickets and provide prizes in the form of cash and/or cashless payment. In some embodiments, gaming terminal apparatus 300 can include a receiving tray 306, which is configured to receive one or more lottery tickets from at least one bin (not shown) inside the gaming terminal apparatus 300 and dispense the one or more lottery tickets to a user. The receiving tray 306 can also receive one or more lottery tickets from a printer (not shown) inside the gaming terminal apparatus.

In some embodiments, gaming terminal apparatus 300 can include a first cable cover 307 and a second cable cover 309. In some embodiments, the gaming terminal apparatus can include a first antenna 308 and a second antenna 310, at least one of which can be configured provide, to the gaming terminal apparatus, data communication through one or more protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes. In some embodiments, the gaming terminal apparatus can include subwoofer 311, which can be configured to work in tandem with the one or more speakers 301.

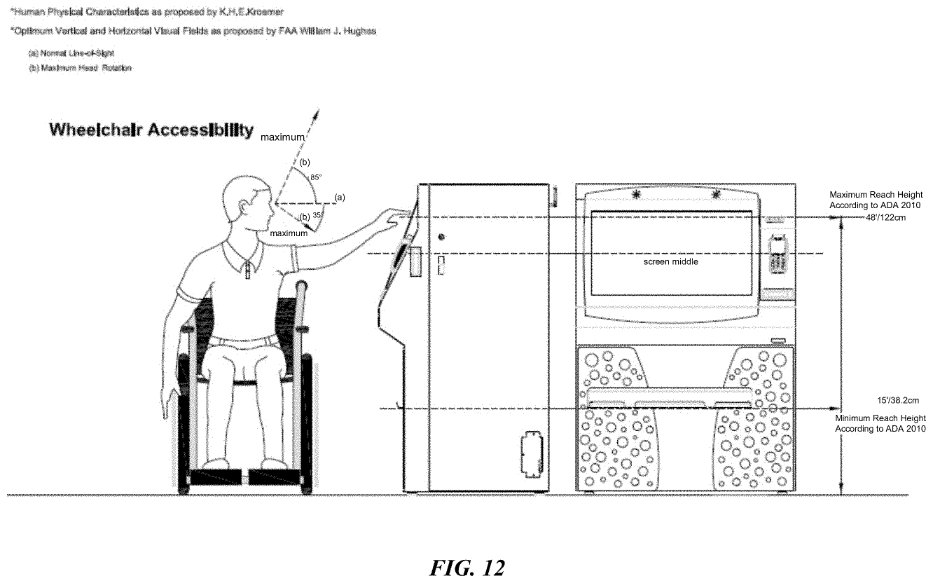

FIG. 12 depicts an exemplary gaming terminal apparatus according to the present disclosure, which comprises an accessibility portion to accommodate an individual in a wheelchair. According to the Americans with Disabilities Act, (“ADA”), the maximum reach height for an individual in a wheelchair is 48 inches whereas the minimum reach height is 15 inches. Thus, in the embodiment shown in FIG. 12, the accessibility portion has a height of 33 inches, which corresponds to the difference between this minimum and maximum reach height.

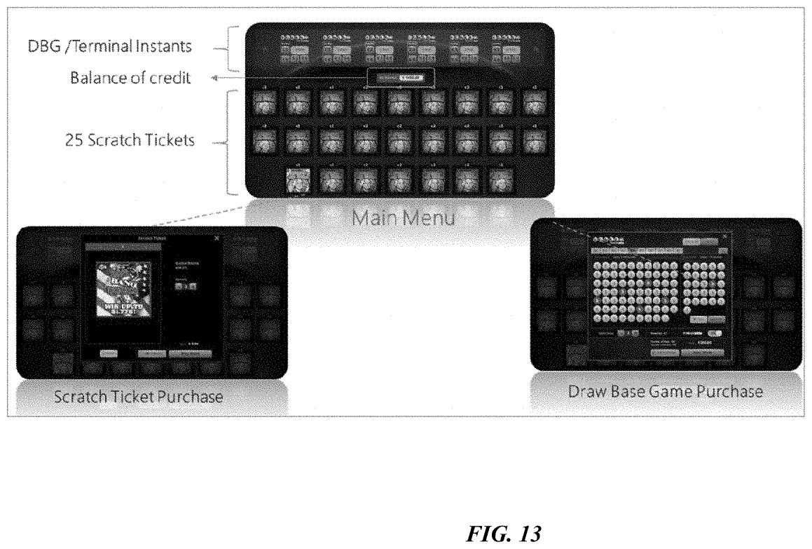

FIG. 13 depicts exemplary screenshots of a graphical user interface (“GUI”) according to the present disclosure. As shown, in some embodiments, the GUI can be configured to display a variety of different menus, such as a main menu which can allow a user to purchase one or more draw based games (DBGs) and from one to twenty-five scratch tickets. As shown, in some embodiments, the GUI can also display a user's credit balance. As shown, in some embodiments, when a game selection is made by the user, the GUI can direct the user to a specific menu corresponding to the selected game (e.g., the DBG or scratch game.) When directed to the specific menu, the user can then purchase the selected game. While not shown in FIG. 13, it is of course envisioned that other types of game selections (i.e., other than a DBG or scratch game) can be made.

At least some aspects of the present disclosure will now be described with reference to the following numbered clauses hereinafter designated as [C1, C2, C3, C4 . . . etc.]

C1: A gaming terminal apparatus, comprising: from five to twenty-five bins, wherein each bin of the one to twenty-five bins is configured to house at least one physical game piece corresponding to at least one of: at least one first game of a first type ; an accessibility portion, wherein the accessibility portion is positioned at a sufficient distance upward from a bottom of the gaming terminal apparatus to allow a user in a wheelchair to play the at least one first game of the first type, the at least one second game of the second type, and the at least one third game of the third type within a single interactive session, and wherein the accessibility portion comprises: an interactive multi-game presenting module that is programmed to display: at least one first interactive graphical user interface that is configured to allow a user to play the at least one first game of a first type; at least one second interactive graphical user interface that is configured to allow the user to play at least one second game of a second type; at least one third interactive graphical user interface that is configured to allow the user to play at least one third game of a third type; wherein the interactive multi-game presenting module is programmed to allow the user to play the at least one first game of the first type, the at least one second game of the second type, and the at least one third game of the third type within the single interactive session; wherein the single interactive session comprises a plurality of time-related activities that the gaming terminal apparatus permits a user to perform during a distinct time period; wherein the at least one first game of the first type, the at least one second game of the second type, and the at least one third game of the third type are distinct; wherein at least one of the at least one first game of the first type, the at least one second game of the second type, or the at least one third game of the third type is a game that requires the gaming terminal apparatus to dispense to the user at least one physical game piece or at least one game entry confirmation printout,; a receiving tray, wherein the receiving tray is configured to receive, from at least one bin of the five to twenty-five bins, at least one of: the at least one first game of the first type, the at least one second game of the second type, or the at least one third game of the third type; at least one hidden internal lock point and at least one hidden internal hinge that is positioned within the gaming terminal apparatus such that a presence of the at least one hidden internal lock point and the at least one hidden internal hinge is not observed from an outside of the gaming terminal apparatus; wherein the at least one hidden internal lock point and at least one hidden internal hinge are configured to prevent unauthorized opening of the gaming terminal apparatus; at least one access sensor that is configured to transmit at least one electronic alarm message upon the gaming terminal apparatus being open without prior authorization; at least one communication module that configured to transmit and receive electronic messages related to an operation of the gaming terminal apparatus; wherein the at least one communication module is configured to operationally control an activation and a deactivation of the gaming terminal apparatus upon a receipt of at least one respective electronic message from an electronic device associated with a person controlling the operation of the gaming terminal apparatus.

C2: The gaming terminal apparatus of C1, wherein the at least one first game of the first type is a first instant scratch game and wherein each corresponding physical game piece of the first instant scratch game is each respective first instant scratch game ticket; wherein the at least one second game of the second type a draw-based game; and wherein the at least one third game of the third type is a terminal instant game.

C3: The gaming terminal apparatus of C2, wherein the gaming terminal apparatus is further configured to automatically update an image representative of the first instant scratch game on the at least one first interactive graphical user interface when the gaming terminal apparatus detects at least one bin of the one to twenty-five bins having a plurality of first instant scratch game tickets.

C4: The gaming terminal apparatus of C2, wherein the gaming terminal apparatus is further configured to automatically determine a length of each respective first instant scratch game ticket.

C5: The gaming terminal apparatus of C3, wherein the gaming terminal apparatus is further configured to automatically track sales of instant scratch game tickets.

C6: The gaming terminal apparatus of C5, wherein the gaming terminal apparatus is further configured to automatically adjust a visual placement of a plurality of instant scratch games on the at least one first interactive graphical user interface based at least in part on the sales of instant scratch game tickets.

C7: The gaming terminal apparatus of C6, wherein the visual placement of the plurality of instant scratch games on the at least one first interactive graphical user interface is distinct from a physical order of each respective bin of the five to twenty-five bins having respective instant scratch game tickets for each respective instant scratch game of the plurality instant scratch games.

C8: The gaming terminal apparatus of C2, wherein the gaming terminal apparatus is further configured to automatically activate each respective pack of instant scratch game tickets before dispensing each respective first instant scratch game ticket to the user.

C9: The gaming terminal apparatus of C1, wherein the interactive multi-game presenting module is in the form of a touch-screen.

C10: The gaming terminal apparatus of C1, wherein the gaming terminal apparatus is in the form of a self-service vending machine.

C11: The gaming terminal apparatus of C1, wherein the accessibility portion is from 10 inches to 33 inches in height.

C12: A method comprising: manufacturing a gaming terminal apparatus, comprising: an accessibility portion, wherein the accessibility portion is positioned at a sufficient distance upward from a bottom of the gaming terminal apparatus to allow a user in a wheelchair to play the at least one first game of the first type, the at least one second game of the second type, and the at least one third game of the third type within the single interactive session, wherein the accessibility portion comprises: an interactive multi-game presenting module that is programmed to display: at least one first interactive graphical user interface that is configured to allow a user to play at least one first game of a first type; at least one second interactive graphical user interface that is configured to allow the user to play at least one second game of a second type; at least one third interactive graphical user interface that is configured to allow the user to play at least one third game of a third type; wherein the interactive multi-game presenting module is programmed to allow the user to play the at least one first game of the first type, the at least one second game of the second type, and the at least one third game of the third type within a single interactive session; wherein the single interactive session comprises a plurality of time-related activities that the gaming terminal apparatus permits a user to perform during a distinct time period; wherein the at least one first game of the first type, the at least one second game of the second type, and the at least one third game of the third type are distinct; wherein at least one of the at least one first game of the first type, the at least one second game of the second type, or the at least one third game of the third type is a game that requires the gaming terminal apparatus to dispense to the user at least one physical game piece or at least one game entry confirmation printout, installing from five to twenty-five bins within the gaming terminal apparatus, wherein each bin of the five to twenty-five bins is configured to house at least one physical game piece corresponding to at least one of: the at least one first game of the first type, the at least one second game of the second type, or the at least one third game of the third type; installing a receiving tray within the accessibility portion; wherein the receiving tray is configured to receive, from at least one bin of the five to twenty-five bins, at least one of: the at least one first game of the first type,; wherein the receiving tray is further configured to receive the at least one second game of the second type, or the at least one third game of the third type; positioning at least one hidden internal lock point and at least one internal hinge within the gaming terminal apparatus such that a presence of the at least one hidden internal lock point and the at least one hidden internal hinge is not observed from an outside of the gaming terminal apparatus; wherein the at least one hidden internal lock point and the at least one hidden internal hinge are configured to prevent unauthorized opening of the gaming terminal apparatus; positioning at least one access sensor within the gaming terminal apparatus, wherein the at least one access sensor is configured to transmit at least one electronic alarm message upon the gaming terminal apparatus being open without prior authorization; positioning at least one communication module within the gaming terminal apparatus, wherein the at least one communication module is configured to transmit and receive electronic messages related to an operation of the gaming terminal apparatus; wherein the at least one communication module is configured to operationally control an activation and a deactivation of the gaming terminal apparatus upon a receipt of at least one respective electronic message from an electronic device associated with a person controlling the operation of the gaming terminal apparatus.

C13: The method of C12, wherein the at least one first game of the first type is a first instant scratch game and wherein each corresponding physical game piece of the first instant scratch game is each respective first instant scratch game ticket; wherein the at least one second game of the second type a draw-based game; and wherein the at least one third game of the third type is a terminal instant game.

C14: The method of C13, wherein the gaming terminal apparatus is further configured to automatically update an image representative of the first instant scratch game on the at least one first interactive graphical user interface when the gaming terminal apparatus detects at least one bin of the five to twenty-five bins having a plurality of first instant scratch game tickets.

C15: the method of C13, wherein the gaming terminal apparatus is further configured to automatically determine a length of each respective first instant scratch game ticket.

C16: The method of C13, wherein the gaming terminal apparatus is further configured to automatically track sales of instant scratch game tickets.

C17: The method of C16, wherein the gaming terminal apparatus is further configured to automatically adjust a visual placement of a plurality instant scratch games on the at least one first interactive graphical user interface based at least in part on the sales of instant scratch game tickets

C18: The method of C17, wherein the visual placement of the plurality instant scratch games on the at least one first interactive graphical user interface is distinct from a physical order of each respective bin of the five to twenty-five bins having respective instant scratch game tickets for each respective instant scratch game of the plurality instant scratch games.

C19: The method of C13, wherein the gaming terminal apparatus is further configured to automatically activate each respective pack of instant scratch game tickets before dispensing each respective first instant scratch game ticket to the user.

C20: The method of C12, wherein the interactive multi-game presenting module is in the form of a touch-screen.

C21: the method of C12, wherein the gaming terminal apparatus is in the form of a self-service vending machine.

C22: The method of C12, wherein the accessibility portion is from 10 inches to 33 inches in height.

C23: The method of C16, wherein the method includes a step of sorting the plurality of instant scratch game tickets based on their price.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

1. A gaming terminal apparatus, comprising:
from five to twenty-five bins,
wherein each bin of the five to twenty-five bins is configured to house at least one physical game piece corresponding to at least one first game of a first type,
an accessibility portion,
wherein the accessibility portion is positioned at a sufficient distance upward from a bottom of the gaming terminal apparatus to allow a user in a wheelchair to play the at least one first game of the first type, the at least one second game of the second type, and the at least one third game of the third type within a single interactive session, and wherein the accessibility portion comprises:
an interactive multi-game presenting module that is programmed to display:
at least one first interactive graphical user interface that is configured to allow a user to play the at least one first game of a first type;
at least one second interactive graphical user interface that is configured to allow the user to play at least one second game of a second type;
at least one third interactive graphical user interface that is configured to allow the user to play at least one third game of a third type;
wherein the interactive multi-game presenting module is programmed to allow the user to play the at least one first game of the first type, the at least one second game of the second type, and the at least one third game of the third type within the single interactive session;
wherein the single interactive session comprises a plurality of time-related activities that the gaming terminal apparatus permits a user to perform during a distinct time period;
wherein the at least one first game of the first type, the at least one second game of the second type, and the at least one third game of the third type are distinct;
wherein at least one of the at least one first game of the first type, the at least one second game of the second type, or the at least one third game of the third type is a game that requires the gaming terminal apparatus to dispense to the user at least one physical game piece or at least one game entry confirmation printout;
a receiving tray,
wherein the receiving tray is configured to receive, from at least one bin of the five to twenty-five bins, the at least one first game of the first type;
wherein the receiving tray is further configured to receive at least one of: the at least one second game of the second type or the at least one third game of the third type;
at least one hidden internal lock point and at least one hidden internal hinge that are positioned within the gaming terminal apparatus such that a presence of the at least one hidden internal lock point and the at least one hidden internal hinge are not observed nor accessed from an outside of the gaming terminal apparatus;
wherein the at least one hidden internal lock point and the at least one hidden internal hinge are configured to prevent unauthorized opening of the gaming terminal apparatus;
at least one access sensor that is configured to transmit at least one electronic alarm message upon the gaming terminal apparatus being open without prior authorization;
at least one communication module that configured to transmit and receive electronic messages related to an operation of the gaming terminal apparatus;
wherein the at least one communication module is configured to operationally control an activation and a deactivation of the gaming terminal apparatus upon a receipt of at least one respective electronic message from an electronic device associated with a person controlling the operation of the gaming terminal apparatus.

2. The gaming terminal apparatus of claim 1,
wherein the at least one first game of the first type is a first instant scratch game and wherein each corresponding physical game piece of the first instant scratch game is each respective first instant scratch game ticket;
wherein the at least one second game of the second type a draw-based game; and
wherein the at least one third game of the third type is a terminal instant game.

3. The gaming terminal apparatus of claim 2, wherein the gaming terminal apparatus is further configured to automatically update an image representative of the first instant scratch game on the at least one first interactive graphical user interface when the gaming terminal apparatus detects at least one bin of the five to twenty-five bins having a plurality of first instant scratch game tickets.

4. The gaming terminal apparatus of claim 2, wherein the gaming terminal apparatus is further configured to automatically determine a length of each respective first instant scratch game ticket.

5. The gaming terminal apparatus of claim 2, wherein the gaming terminal apparatus is further configured to automatically track sales of instant scratch game tickets.

6. The gaming terminal apparatus of claim 5, wherein the gaming terminal apparatus is further configured to automatically adjust a visual placement of a plurality of instant scratch games on the at least one first interactive graphical user interface based at least in part on the sales of instant scratch game tickets.

7. The gaming terminal apparatus of claim 6, wherein the visual placement of the plurality of instant scratch games on the at least one first interactive graphical user interface is distinct from a physical order of each respective bin of the five to twenty-five bins having respective instant scratch game tickets for each respective instant scratch game of the plurality instant scratch games.

8. The gaming terminal apparatus of claim 2, wherein the gaming terminal apparatus is further configured to automatically activate each respective pack of instant scratch game tickets before dispensing each respective first instant scratch game ticket to the user.

9. The gaming terminal apparatus of claim 1, wherein the interactive multi-game presenting module is in the form of a touch-screen.

10. The gaming terminal apparatus of claim 1, wherein the gaming terminal apparatus is in the form of a self-service vending machine.

11. The gaming terminal apparatus of claim 1, wherein the accessibility portion is from 10 inches to 33 inches in height.

12. A method comprising:
manufacturing a gaming terminal apparatus, comprising:
an accessibility portion, wherein the accessibility portion is positioned at a sufficient distance upward from a bottom of the gaming terminal apparatus to allow a user in a wheelchair to play the at least one first game of the first type, the at least one second game of the second type, and the at least one third game of the third type within the single interactive session, wherein the accessibility portion comprises:
an interactive multi-game presenting module that is programmed to display:
at least one first interactive graphical user interface that is configured to allow a user to play at least one first game of a first type;
at least one second interactive graphical user interface that is configured to allow the user to play at least one second game of a second type;
at least one third interactive graphical user interface that is configured to allow the user to play at least one third game of a third type;
wherein the interactive multi-game presenting module is programmed to allow the user to play the at least one first game of the first type, the at least one second game of the second type, and the at least one third game of the third type within a single interactive session;
wherein the single interactive session comprises a plurality of time-related activities that the gaming terminal apparatus permits a user to perform during a distinct time period;
wherein the at least one first game of the first type, the at least one second game of the second type, and the at least one third game of the third type are distinct;
wherein at least one of the at least one first game of the first type, the at least one second game of the second type, or the at least one third game of the third type is a game that requires the gaming terminal apparatus to dispense to the user at least one physical game piece or at least one game entry confirmation printout;
installing from five to twenty-five bins within the gaming terminal apparatus,
wherein each bin of the five to twenty-five bins is configured to house at least one physical game piece corresponding to at least one of: the at least one first game of the first type,
installing a receiving tray within the accessibility portion;
wherein the receiving tray is configured to receive, from at least one bin of the five to twenty-five bins of the at least one first game of the first type,
wherein the receiving tray is further configured to receive at least one of: the at least one second game of the second type, or the at least one third game of the third type;
positioning at least one hidden internal lock point and at least one internal hinge within the gaming terminal apparatus such that a presence of the at least one hidden internal lock point and the at least one hidden internal hinge are not observed nor accessed from an outside of the gaming terminal apparatus;
wherein the at least one hidden internal lock and the at least one hidden internal hinge are configured to prevent unauthorized opening of the gaming terminal apparatus;
positioning at least one access sensor within the gaming terminal apparatus, wherein the at least one access sensor is configured to transmit at least one electronic alarm message upon the gaming terminal apparatus being open without prior authorization;
positioning at least one communication module within the gaming terminal apparatus, wherein the at least one communication module is configured to transmit and receive electronic messages related to an operation of the gaming terminal apparatus;
wherein the at least one communication module is configured to operationally control an activation and a deactivation of the gaming terminal apparatus upon a receipt of at least one respective electronic message from an electronic device associated with a person controlling the operation of the gaming terminal apparatus.

13. The method of claim 12, wherein the at least one first game of the first type is a first instant scratch game and wherein each corresponding physical game piece of the first instant scratch game is each respective first instant scratch game ticket;
wherein the at least one second game of the second type a draw-based game; and
wherein the at least one third game of the third type is a terminal instant game.

14. The method of claim 13, wherein the gaming terminal apparatus is further configured to automatically update an image representative of the first instant scratch game on the at least one first interactive graphical user interface when the gaming terminal apparatus detects at least one bin of the five to twenty-five bins having a plurality of first instant scratch game tickets.

15. The method of claim 13, wherein the gaming terminal apparatus is further configured to automatically determine a length of each respective first instant scratch game ticket.

16. The method of claim 13, wherein the gaming terminal apparatus is further configured to automatically track sales of instant scratch game tickets.

17. The method of claim 16, wherein the gaming terminal apparatus is further configured to automatically adjust a visual placement of a plurality instant scratch games on the at least one first interactive graphical user interface based at least in part on the sales of instant scratch game tickets.

18. The method of claim 17, wherein the visual placement of the plurality instant scratch games on the at least one first interactive graphical user interface is distinct from a physical order of each respective bin of the five to twenty-five bins having respective instant scratch game tickets for each respective instant scratch game of the plurality instant scratch games.

19. The method of claim 13, wherein the gaming terminal apparatus is further configured to automatically activate each respective pack of instant scratch game tickets before dispensing each respective first instant scratch game ticket to the user.

20. The method of claim 12, wherein the interactive multi-game presenting module is in the form of a touch-screen.

21. The method of claim 12, wherein the gaming terminal apparatus is in the form of a self-service vending machine.

22. The method of claim 12, wherein the accessibility portion is from 10 inches to 33 inches in height.

23. The method of claim 16, further comprising a step of sorting the plurality of instant scratch game tickets based on price.
